(19) United States
(12) Patent Application Publication
(10) Pub. No.: US 2016/0163223 A1
(43) Pub. Date: Jun. 9, 2016

(54) SYSTEM AND METHOD TO ENABLE PURSUIT OF HAPPINESS

(71) Applicants: Sasidhar JONNALAGADDA, New York, NY (US); Sreenidhi SUNDARAN, Bangalore (IN); Manisha Naresh NAGPAL, Bangalore (IN)

(72) Inventors: Sasidhar JONNALAGADDA, New York, NY (US); Sreenidhi SUNDARAN, Bangalore (IN); Manisha Naresh NAGPAL, Bangalore (IN)

(73) Assignee: DHARMA SYSTEMS INC., SLEEPY HOLLOW, NY (US)

(21) Appl. No.: 14/697,637

(22) Filed: Apr. 28, 2015

Related U.S. Application Data
(63) Continuation-in-part of application No. 14/549,536, filed on Nov. 20, 2014.

(51) Int. Cl. G09B 19/00

(52) U.S. Cl. CPC G09B 19/00

(57) ABSTRACT

A system to enable pursuit of happiness is provided. The system includes one or more processors configured to provide a user with options in a sequence. The sequence of options comprises option to select at least one weak personality trait to be worked on, option to select at least one weak relationship to be worked on, wherein the option to select the at least one weak relationship is recommended after recommending the option to select the at least one weak personality trait, and option to select happiness as a trait to be worked on, wherein the option to select happiness as a trait is recommended after recommending the option to select the at least one weak relationship.

### CROSS REFERENCE TO RELATED APPLICATIONS

This application is a continuation-in-part of U.S. patent application Ser. No. 14/549,536 filed Nov. 20, 2014.

### BACKGROUND

1. Field

The subject matter in general relates to human traits. More particularly, but not exclusively, the subject matter relates to a technical solution to pursue happiness in a systematic manner.

2. Discussion of Related Art

Each and every individual try to shape their lives in such a way that they can stay happy. Some individuals are characteristically happier than others, whereas some of the individuals are unhappy even if the living conditions are same. The assumption is that some of the individuals may be experiencing limitations that hold them back from being happy.

Conventionally, individuals who think they are unhappy may seek professional help, who may provide counselling and/or prescribe medication. Despite such counselling and medication, it has been observed that many individuals may still feel the lack of happiness in their lives.

In light of the foregoing discussion, there is a need for a technical solution that may enable individuals to systematically improve happiness quotient in their lives.

### SUMMARY

An embodiment system to enable pursuit of happiness. The system includes one or more processors configured to provide a user with options in a sequence. The sequence of options comprises option to select at least one weak personality trait to be worked on, option to select at least one weak relationship to be worked on, wherein the option to select the at least one relationship is recommended after recommending the option to select the at least one weak personality trait, and option to select happiness as a trait to be worked on, wherein the option to select happiness as a trait is recommended after recommending the option to select the at least one relationship.

### BRIEF DESCRIPTION OF DRAWINGS

Embodiments are illustrated by way of example and not limitation in the Figures of the accompanying drawings, in which like references indicate similar elements and in which:

FIG. 1 is an exemplary architecture of an exemplary system 100 to enable pursuit of happiness, in accordance with an embodiment;

FIG. 2A is an exemplary block diagram of the system 100, in accordance with an embodiment;

FIG. 2B is an exemplary block diagram of a database module 204 of the system 100, in accordance with an embodiment; and

FIGS. 3A and 3B are flowcharts of an exemplary technical method to enable pursuit of happiness, in accordance with an embodiment.

### DETAILED DESCRIPTION

An embodiment provides a system to enable pursuit of happiness. The system may include an application executed by one or more processors configured to provide a user with options in a sequence. The sequence of options may include option to select at least one weak personality trait to be worked on, option to select at least one weak relationship to be worked on and option to select happiness as trait to be worked on, in the sequence presented. The application is configured to provide or recommend the option to select at least one weak relationship to be worked on, only after providing or recommending the option to select at least one weak personality trait to be worked on. Further, the application is configured to provide or recommend the option to select happiness as the trait to be worked on, only after providing or recommending the option to select at least one weak relationship to be worked on. For example, the application may be executed on a user's mobile device. The application may provide the user a first option to select at least one long term weak personality trait. The user, who may be experiencing a negative personality trait such as “anger”, may select “anger” as a personality trait to be improved. The application may subsequently suggest a choice of actions to be performed by the user to improve the selected trait. The user may select some of the actions. Once the user has performed the selected actions at least to an extent set by the application, the application may provide the option to select at least one weak relationship to be worked on. The user may be experiencing an unhealthy relationship with his or her “spouse”. The user may select “spouse” as a weak relationship to be improved. The application may suggest a choice of actions to be performed by the user to improve the selected weak relationship. The user may select some of the actions. Once the user has performed the selected actions at least to an extent set by the application, the application may provide the option to select happiness as a trait to be worked on The user may select happiness as a trait to be worked on. Subsequently, the application may suggest a choice of actions to be performed by the user to achieve/improve/enhance happiness as a trait. The application may be further configured to determine status of the one or more personality traits, if selected by the user, based on performance of actions corresponding to the one or more personality traits, at a stage wherein the user has selected and working on at least one of the relationship and happiness as the trait. The application may be further configured to determine status of the one or more relationships, if selected by the user, based on performance of actions corresponding to the one or more relationships, at a stage wherein the user is working on happiness as the trait.

The following detailed description includes references to the accompanying drawings, which form part of the detailed description. The drawings show illustrations in accordance with example embodiments. These example embodiments are described in enough detail to enable those skilled in the art to practice the present subject matter. However, it will be apparent to one of ordinary skill in the art that the present invention may be practiced without these specific details. In other instances, well-known methods, procedures and components have not been described in detail so as not to unnecessarily obscure aspects of the embodiments. The embodiments can be combined, other embodiments can be utilized or structural and logical changes can be made without departing from the scope of the invention. The following detailed description may, therefore, not to he taken as a limiting sense.

In this document, the terms “a” or “an” are used, as is common in patent documents, to include one or more than one. In this document, the term “or” is used to refer to a nonexclusive “or,” such that “A or B” includes “A but not B,” “B but not A,” and “A and B,” unless otherwise indicated.

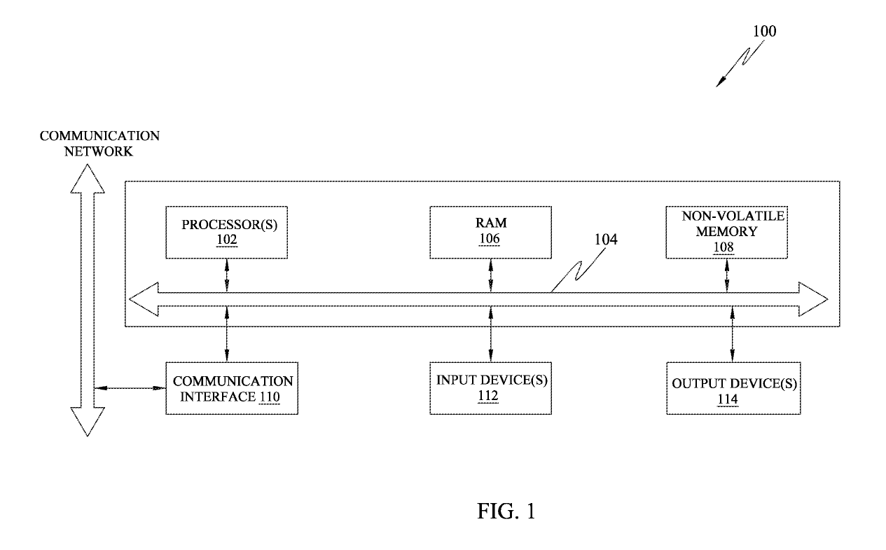

Referring to the figures, more particularly to FIG. 1, an exemplary architecture of an exemplary system 100 to enable pursuit of happiness. The system 100 include one or more processors 102, a bus system 104, a random access memory 106, a disk drive or non-volatile memory 108, a communication interface 110, input device(s) 112 and output device(s) 114. Further, functionality of the system 100 may be distributed across multiple devices that may be located remotely from each other.

The processor 102 may be any hardware which returns output by accepting signals, such as electrical signals as input. In one embodiment, processors 102 may include one or more computer processing units (CPUs). The processor(s) 102 may communicate with a number of peripheral devices via the bus system 104. The processor(s) 102 may be implemented as appropriate in hardware, computer-executable instructions, firmware, or combinations thereof. Computer-executable instruction or firmware implementations of the processor(s) 102 may include computer-executable or machine-executable instructions written in any suitable programming language to perform the various functions described.

Communications interface 110 may provide an interface to other communication networks and devices. The input devices 112 may include all possible types of devices and mechanisms for inputting information to system 100. The output devices 114 may include all possible types of devices and mechanisms fur outputting information from the system 100. The system 100 may include memory that may store data and program instructions that are loadable and executable on the processor(s) 102, as well as data generated during the execution of these programs. The memory may be volatile, such as random access memory 106 and/or a disk drive or non-volatile memory 108.

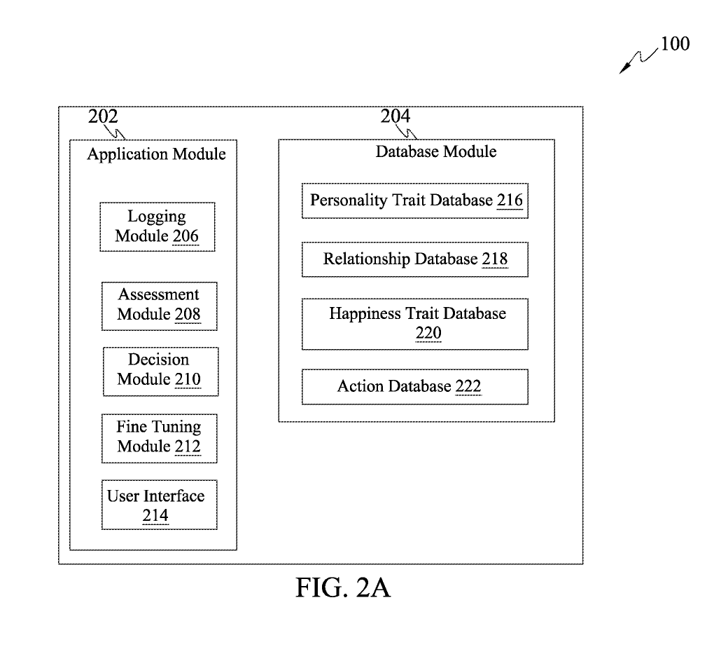

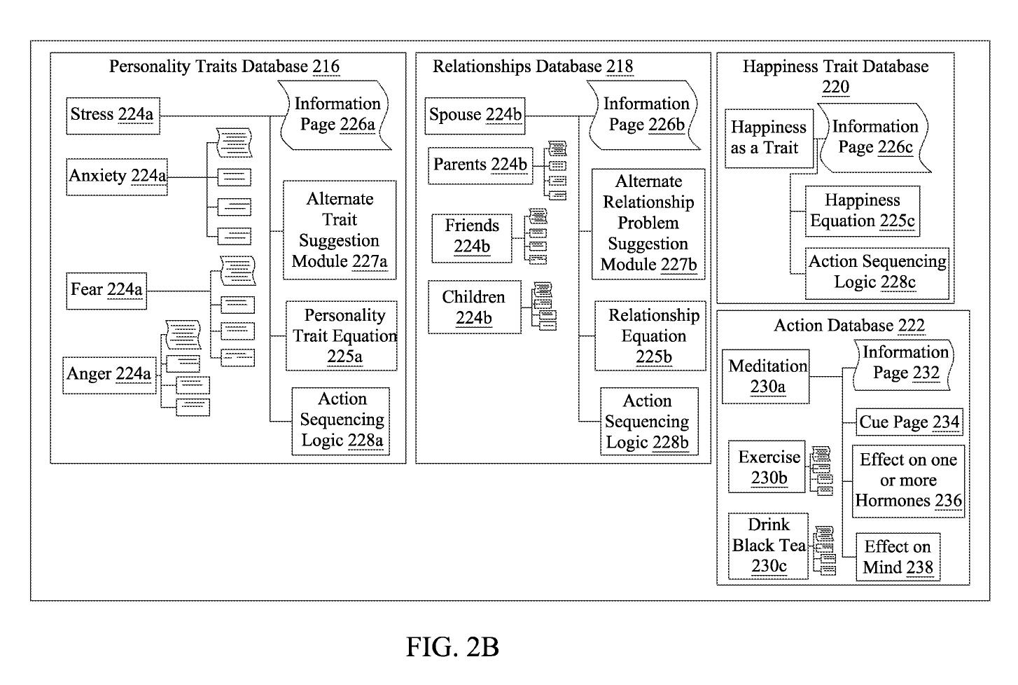

Now also referring to FIG. 2A and FIG. 2B, the system 100 may be supported/hosted/executed by the architecture illustrated in FIG. 1. The architecture may be of a data processing device, and preferably of a mobile data communication device. Examples of a mobile data communication device include, but are not limited to, smart phone, smart watch, tablet, phablet and laptop, among others. The system 100 may include an application module 202 and a database module 204. The application module 202 may executed by the processor(s) 102, and the database module 204 may stored in the memory 108.

The application module 202 may include a logging module 206, an assessment module 208, a decision module 210, a fine tuning module 212 and a user interface module 214.

The database module 204 may include a personality traits database 216, a relationships database 218, a happiness trait database 220 and an actions database 222.

In an embodiment, the personality traits database 216 may include a list of personality traits, such as stress 224a, anxiety 224a, tear 224a and anger 224a (may be referred to as “personality trait 224a”), among others. The personality traits may mean and include one or more of human traits and emotional traits. Each personality trait 224a may be associated with a personality trait equation 225a, an information page 226a, an alternate trait suggestion module 227a and an action sequencing logic 228a.

In an embodiment, the relationships database 218 may include a list of relationships to be worked on, such as spouse 224b, parents 224b, friends 224b and children 224b (may be referred to as “relationship 224b”), among others. Relationships may mean and include one or more of social and personal relationships. Each relationship 224b may be associated with a relationship equation 225b (may be same or similar to the personality trait equation 225a), an information page 226b, an alternate relationship problem suggestion module 227b and an action sequencing logic 228b.

In an embodiment, the happiness trait database 220 may happiness equation 225c (may be same or similar to the personality trait equation 225a), an information page 226c and an action sequencing logic 228c.

The personality trait 224a for a personality trait includes an equation for determining current status of the trait. An exemplary trait equation is provided below:

$${T}_{V} = {T}_{I} + Min ( {E}_{Hmax} , {E}_{H} ) + Min ( {E}_{Mmax} , {E}_{M} )$$

$${E}_{H} = {h}_{1} * \frac{{H}_{1}}{100} + {h}_{2} * \frac{{H}_{2}}{100} + {h}_{3} * \frac{{H}_{3}}{100} + …$$

$${E}_{M} = m 1 {( \frac{1}{2} )}^{\frac{t 1}{t 1 half}} + m 2 {( \frac{1}{2} )}^{\frac{t 2}{t 2 half}} + m 3 {( \frac{1}{2} )}^{\frac{t 3}{t 3 half}} + …$$

$${H}_{1} = a 1 {( \frac{1}{2} )}^{( \frac{t a 1}{th 1 half} )} + a 2 {( \frac{1}{2} )}^{( \frac{t a 2}{th 1 half} )} + a 3 {( \frac{1}{2} )}^{( \frac{t a 3}{th 1 half} )} + …$$

Where,
Tᵥ: Current trait value;
T_{I}: User defined trait value;
E_{Hmax}: Maxim effectiveness of doing only physical and dietary actions;
E_{Mmax}: Maximum effectiveness of doing only mind and brain actions;
E_{H}: Current effectiveness of all physical and dietary actions performed by user;
E_{M}: Current effectiveness of all mind and brain actions performed by user;
h1, h2 and h3 are the weightage for the hormones;
H1, H2 and H3 are the current absolute percentage changes from the normal level of hormones;
a1, a2, a3 are the initial percentage increase of the hormone for its corresponding physical or food action;
ta1, ta2, ta3 are the elapsed time from the time each of the respective actions (a1, a2, a3) was taken;
th1 half is the half life or deterioration of the hormone's (H1) effect on the trait;
m1, m2, m3 are the initial percentage improvement in the trait for its corresponding mind action;
t1, t2, t3 are the elapsed time from the time each of the respective actions (m1, m2, m3) was taken; and
t1half, t2half, t3half are the half life or deterioration of the actions (m1, m2, m3) effect on the trait.

In an embodiment, for relationship equation 225b, the values for “trait” may be replaced/substituted with values corresponding to “relationship”.

In an embodiment, for happiness equation 225c, the values for “trait” may be replaced/substituted with values corresponding to “happiness”.

The information page 226a may include information corresponding to the respective trait. The information corresponding to the trait may include information corresponding to reasons causing the trait, symptoms corresponding to the trait, impact of the trait on a person and other traits that may be confused with the instant trait, among other information. The information page 226a may even enable selection of an alternate trait to work on instead of the trait to which the information page 226a relates.

Similarly, the information page 226b may include information corresponding to the respective relationship or relationship problem. The information corresponding to the relationship or relationship problem may include information corresponding to reasons causing the problem, symptoms corresponding to the problem, impact of the problem on a person and other relationship problems that may be confused with the instant relationship (problem, among other information. The information page 226b may even enable selection of an alternate relationship/relationship problem to work on instead of the relationship/relationship problem to which the information page 226b relates.

Likewise, the information page 226c may include information corresponding to happiness. The information corresponding to happiness may include information corresponding to reasons causing the problem, symptoms corresponding to the problem, impact of the problem on user and others, among other information.

In an embodiment, the alternate trait suggestion module 227a corresponding to a trait may include a list of one or more traits other than the instant trait, which may be selected by the user.

Likewise, in an embodiment, the alternate relationship problem suggestion module 227b corresponding to a relationship or relationship problem may include a list of one or more relationships or relationship problems other than the instant relationship or relationship problem, which may be selected by the user.

The action sequencing logic 228a may include instructions that may enable the decision module 210 to suggest one or more actions to be performed to improve the respective trait. The action sequencing logic 228a may includes instructions to suggest actions based on one or more criteria, such as, but not limited to, simplicity of performing each of the actions, effectiveness of each of the actions in changing the status of the selected personality trait, the trait equation 225a associated with the selected trait, status of the selected trait and the actions which have been previously executed by the user.

Similarly, the action sequencing logic 228b may include instructions that may enable the decision module 210 to suggest one or more actions to be performed to improve the respective relationship or relationship problem. The action sequencing logic 228b may includes instructions to suggest actions based on one or more criteria, such as, but not limited to, simplicity of performing each of the actions, effectiveness of each of the actions in changing the status of the selected relationship or relationship problem, the relationship equation 224b associated with the selected relationship or relationship problem, status of the selected relationship or relationship problem and the actions which have been previously executed by the user.

Likewise, the action sequencing logic 228c may include instructions that may enable the decision module 210 to suggest one or more actions to be performed to increase happiness. The action sequencing logic 228c may includes instructions to suggest actions based on one or more criteria, such as, but not limited to, simplicity of performing each of the actions, effectiveness of each of the actions in changing the status of happiness, the happiness equation 224c, status of happiness and the actions which have been previously executed by the user,

In an embodiment, the action database 222 includes a list of actions that may be associated with at least one of a physical action, a mind action and a dietary action. There may be present, actions associated with brain action. Actions, for example can be, meditation 230a, exercise 230b and drinking black tea 230c, among others. An action, such as exercise 230a may be physical actions; meditation 230b may be mind actions; and drinking black tea 230c may be dietary action. Each action 230 may be associated with an information page 232, a cue page 234, effect on one or more hormones 236 and effect on mind 238 corresponding to one or more of one or more traits, one or more relationships or relationship problems, and happiness, among others.

The information page 232 may include information corresponding to the action 230, such as methodology of performing an action and preparation, among others. The information may be in the form of one or more of text, image, video and audio.

The cue page 234 or an action page may provide information about when and where the action may he performed. The cue page 234 or the action page may further include information about the advantage(s) of performing the action.

Effect on one or more hormones 236 may include values, such as numeric values reflecting the impact of performing the action on one or more hormones. The value(s) may be used in the trait/relationship/happiness equation. Similarly, effect on mind 238 may include values, such as numeric values reflecting the impact of performing the action on the mind in relation to one or more traits trait/relationship/relationship problems/happiness. The value(s) may be used in the trait/relationship/happiness equation.

In an embodiment, the logging module 206 enables logging of the actions performed by the user. The logging module 206 may record information corresponding to the actions performed by the user. The information may include one or more of, time of performance, date of performance, quantum of performance, success or failure consequent to an attempt to perform, and extent of success in performing the action, among others. The user provides an input that an action has been performed. Such input is used to log the action in the logging module 206. Alternatively, the logging module 206 may be configured to automatically log the performance of an action, upon detection that the action has been performed. For example, the application module 202 may provide an action such as solving a quiz. As soon as the quiz is solved or attempted to be solved, the information corresponding to the performance of the action may be logged in the logging module 206.

In an embodiment, the logging module 206 may maintain a log of actions to be performed by the user based on the actions selected by the user. The log may include all the actions selected by the user while the user selected to work on one or more of, one or more traits, one or more relationships or relationship problems, and happiness, among others.

The assessment module 208 of the application module 202 is configured to determine the current status of a selected personality trait 224a, a selected relationship or relationship problem 224b and happiness as a trait 224c if selected. The assessment module 108 uses the information from the logging module 206, trait equation 225a or relationship equation 225b or happiness equation 225c (as the case may be), the effect of the actions 230 performed on one or more hormones 236 and effect on mind 238 corresponding to the trait 224a, relationship or relationship problem 224b or happiness as a trait 224c (as the case may be), to determine the current status of the personality trait 224a, selected relationship or relationship problem 224b, and happiness as a trait 224c (as the case may be).

In an embodiment, the assessment module 208 may determine status of the one or more personality traits, if selected by the user, based on performance of actions corresponding to the one or more personality traits, at a stage wherein the user has selected and working on at least one of the relationship and happiness as the trait; and determine status of the one or more relationships, if selected by the user, based on performance of actions corresponding to the one or more relationships, at a stage wherein the user is working on at least one happiness as a trait and one or more other traits.

In an embodiment, the fine tuning module 212 is configured to reconfigure the effectiveness of one or more actions on trait(s)/relationship(s)/relationship problem(s)/happiness for future computation of status of the trait(s) trait(s)/relationship(s)/relationship problem(s)/happiness. The reconfiguration may be based on the difference between a user's perception of the status of a trait(s)/relationship(s)/relationship problem(s)/happiness and the status of the trait(s)/relationship(s)/relationship problem(s)/happiness as computed by the assessment module 208.

In an embodiment, the user interface module 214 may be configured to enable a user to interact with the system 100. The user interface 214 may allow the user to provide input to the application module 202. Further, the system 100 may provide information and/or instructions to the user via the user interface module 214.

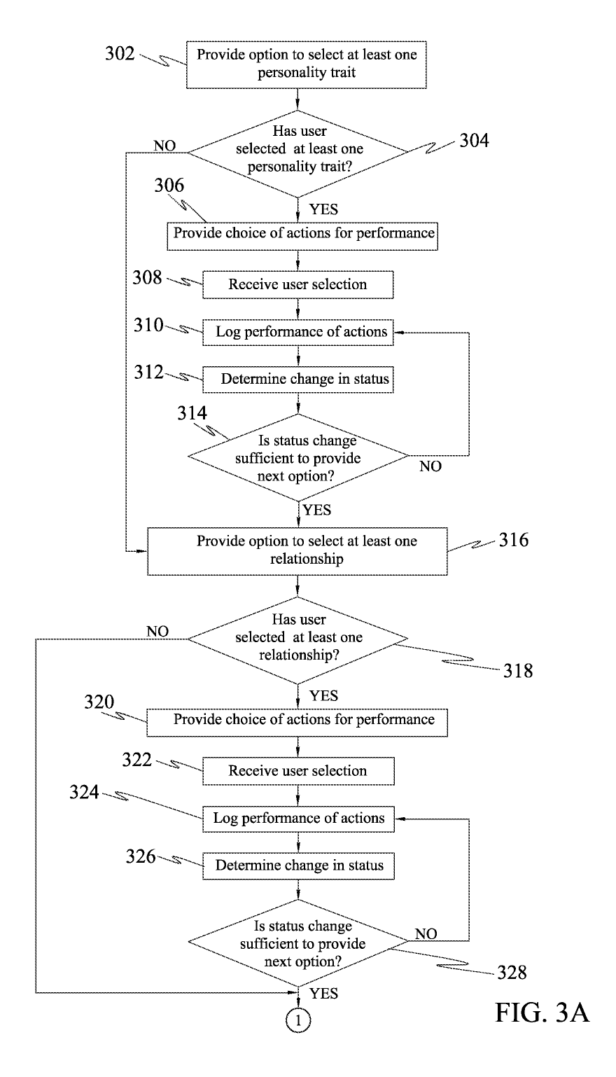

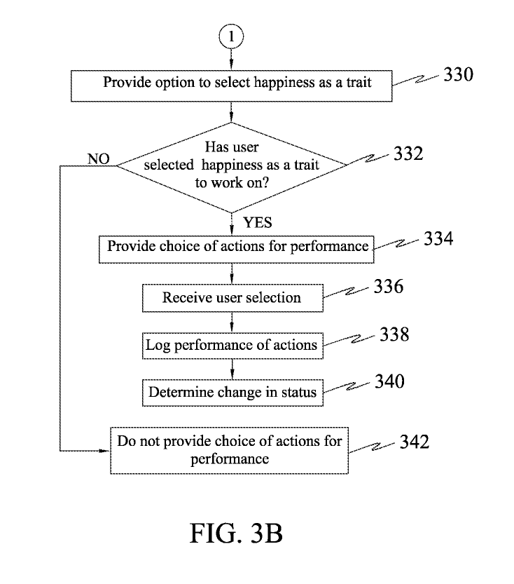

Referring to FIGS. 3A and 3B as well, a method to enable pursuit of happiness is provided. The decision module 210, at step 302, provides or recommends an option over the user's device to select at least one weak personality trait to be worked on. The use may select one of the several weak personality traits that may be displayed to the user. Alternatively, the user may input a query into the system 100, which may provide one or more search results, which may include a personality trait for selection. If the user selects a weak personality trait to be worked on, at step 304, then the user may be provided with option(s) to indicate the current status of the selected trait. Further, the action sequencing logic 228a, at step 306, may provide a choice of actions for performance by the user, corresponding to the selected weak personality trait. The choice of actions may include actions related to physical, dietary and mind actions. The user may select one or more actions for performance from the choice offered to him. The user selection may be received, at step 308, by the logging module 206. The logging module 206 may provide reminders or prompt the user to perform the actions selected. The reminders or prompt may be based on the schedule set by the user or schedule prescribed for the selected actions. The logging module 206, at step 310, may log information corresponding to the performance of the selected actions. The assessment module 208, at step 312, may determine the current status of the selected personality trait, consequent to the information recorded by the logging module 206. The decision module 210, at step 314, may check if the selected action(s) have been performed at least to an extent or the status of the selected trait has changed at least to an extent to provide a further option to the user.

The selected action(s), if performed at least to a predefined extent or the status of the selected trait has changed at least to a predefined extent, then at step 316, the decision module 210 may provide or recommend an option over the user's device to select at least one weak relationship to be worked on. The use may select one of the several relationships that may be displayed to the user. Alternatively, the user may input a query into the system 100, which may provide one or more search results, which may include a relationship for selection. Alternatively, the decision module 210 may provide or recommend an option to select another weak personality trait to be worked on, before providing or recommending the option to select a weak relationship to be worked on. Alternatively, the decision module 210 may provide or recommend an option to select another weak personality trait to be worked on along with the option to select a weak relationship to be worked on.

The decision module 210 may provide or recommend the option to select a weak relationship to be worked on, if at step 304, the user chooses not to select at least one weak personality trait to be worked on. Hence, the decision module 210 may allow selection of one of the options (option to work on weak relationship or happiness) without selecting a preceding option (selecting a weak personality trait to work on). In an embodiment, the system 100 may generate an alert instructing about consequences of skipping the preceding option. As an example, the alert may indicate that success in improving relationships may be limited if certain weak personality traits are not addressed first.

At step 318, if the user selects a weak relationship to be worked on, then the user may be provided with option(s) to indicate the current status of the relationship. Further, the action sequencing logic 228b, at step 320, may provide a choice of actions for performance by the user, corresponding to the selected relationship. The choice of actions may include actions related to one or more of physical, dietary and mind actions. The user may select one or more actions for performance from the choice offered to him. The user selection may be received, at step 322, by the logging module 206. The logging module 206 may also include actions that were selected previously. The logging module 206 may provide reminders or prompt the user to perform the actions selected (as an example, at present and previously related to traits). The reminders or prompt may be based on the schedule set by the user or schedule prescribed for the selected actions. The logging module 206, at step 324, may log information corresponding to the performance of the selected actions. The assessment module 208, at step 326, may determine the current status of the selected relationship, consequent to the information recorded by the logging module 206. The assessment module 208 may also determine the current status of the previously selected trait(s) by the user. The decision module 210, at step 328, may check if the selected action(s) have been performed at least to an extent or the status of the selected relationship has changed at least to an extent to provide or recommend a further option to the user.

The selected action(s), if performed at least to a predefined extent or the status of the selected relationship has changed at least to a predefined extent, at step 328, then the decision module 210, at step 330, may provide or recommend an option over the user's device to select happiness as a trait to be worked on. Alternatively, the decision module 210 may provide or recommend an option to select at least one another weak relationship or weak personality trait to be worked on, before providing or recommending the option to select happiness as a trait to be worked on. Alternatively, the decision module 210 may provide or recommend an option to select at least one weak relationship or weak personality trait to be worked on along with the option to select happiness as a trait to be worked on.

The decision module 210 may provide or recommend the option to select happiness as a trait to be worked on, if at step 304, the user chooses not to select at least one weak personality trait to be worked on or if at step 318, the user chooses not to select at least one weak relationship to be worked on. Hence, the decision module 210 may allow selection of happiness to be worked on without selecting a preceding option (selecting a weak personality trait to work on or selecting a weak relationship or relationship problem to work on). In an embodiment, the system 100 may generate an alert instructing about consequences of skipping the preceding option. As an example, the alert may indicate that success in enhancing happiness may be limited if certain weak personality traits are not addressed. As another example, the alert may indicate that success in enhancing happiness may be limited if certain weak relationships are not addressed.

At step 332, if the user selects happiness as a trait to be worked on, then the user may be provided with option(s) to indicate the current status of happiness. Further, the action sequencing logic 228c, at step 334, may provide a choice of actions for performance by the user, corresponding to happiness. The choice of actions may include actions related to one or more of physical, dietary and mind actions. The user may select one or more actions for performance from the choice offered to him. The user selection may be received, at step 336, by the logging module 206. The logging module 206 may also include actions that were selected previously. The logging module 206 may provide reminders or prompt the user to perform the actions selected (as an example, at present and previously related to traits/relationships/relationship problems). The reminders or prompt may be based on the schedule set by the user or schedule prescribed for the selected actions. The logging module 206, at step 338, may log information corresponding to the performance of the selected actions. The assessment module 208, at step 340, may determine the current status of happiness as a trait, consequent to the information recorded by the logging module 206. The assessment module 208 may also determine the current status of the previously selected trait(s)/relationships by the user. The system 100 may not provide any choice of actions for performance, if the user does not select any of the options (step 342).

It shall be noted that the processes described above is described as sequence of steps, this was done solely for the sake of illustration. Accordingly, it is contemplated that some steps may be added, some steps may be omitted, the order of the steps may be re-arranged, or some steps may be performed simultaneously.

Although embodiments have been described with reference to specific example embodiments, it will be evident that various modifications and changes may be made to these embodiments without departing from the broader spirit and scope of the system and method described herein. Accordingly, the specification and drawings are to be regarded in an illustrative rather than a restrictive sense.

Many alterations and modifications of the present invention will no doubt become apparent to a person of ordinary skill in the art after having read the foregoing description. It is to be understood that the phraseology or terminology employed herein is for the purpose of description and not of limitation. It is to be understood that the description above contains many specifications, these should not be construed as limiting the scope of the invention but as merely providing illustrations of some of the personally preferred embodiments of this invention. Thus the scope of the invention should be determined by the appended claims and their legal equivalents rather than by the examples given.

What is claimed is:

1. A system to enable pursuit of happiness, wherein the system comprises one or more processors configured to:
provide a user with options in a sequence, wherein the sequence of options comprises:
option to select at least one weak personality trait to be worked on;
option to select at least one weak relationship to be worked on, wherein the option to select the at least one weak relationship is recommended after recommending the option to select the at least one weak personality trait; and
option to select happiness as a trait to be worked on, wherein the option to select happiness as a trait is recommended after recommending the option to select the at least one weak relationship.

2. The system according to claim 1, wherein the one or more processors are further configured to allow selection of one of the options without selecting a preceding option.

3. The system according to claim 1, wherein the one or more processors are further configured to generate an alert instructing about consequences of skipping the preceding option.

4. The system according to claim 1, wherein the one or more processors are further configured to suggest at least one action for selection and performance by the user, based on the option selected by the user, wherein the action is intended to provide an improvement in the user's weak personality trait, relationship or enhance happiness as a trait, as is the case based on the option selected.

5. The system according to claim 4, wherein the one or more processors are further configured to:
recommend the option to select the at least one weak relationship to be worked on, only after performance of at least one of the actions suggested based on the selection of the at least one weak personality trait to be worked on; and
recommend the option to select happiness as the trait to be worked on, only after performance of at least one of the actions suggested based on the selection of the at least one weak relationship to be worked on.

6. The system according to claim 5, wherein the one or more processors are further configured to:
recommend an option to select another weak personality trait to be worked on, before providing the option to select the at least one weak relationship to be worked on; and
recommend an option to select another weak relationship to be worked on, before providing the option to select happiness as the trait to be worked on.

7. The system according to claim 4, wherein the one or more processors are further configured to maintain a log of actions for performance by the user based on the actions selected by the user.

8. The system according to claim 7, wherein the log comprises all the actions selected by the user.

9. The system according to claim 4, wherein the one or more processors are further configured to:
determine status of the at least one personality trait, if selected by the user, based on performance of actions corresponding to the one or more personality traits, at a stage wherein the user has selected and working on at least one of the relationship and happiness as the trait; and
determine status of the at least one relationship, if selected by the user, based on performance of actions corresponding to the at least one relationships, at a stage wherein the user is working on happiness as the trait.

10. A non-transitory computer-readable medium storing computer-executable code to enable pursuit of happiness, the non-transitory computer-readable medium comprising code to:
recommend an option to select at least one weak personality trait to be worked on;
recommend an option to select at least one weak relationship to be worked on, only after recommending the option to select the at least one weak personality trait; and
recommend an option to select happiness as a trait to be worked on, only after recommending the option to select the at least one weak relationship.

11. A computer-implemented method comprising:
recommending an option to select at least one weak personality trait to be worked on;
recommending an option to select at least one weak relationship to be worked on, only after recommending the option to select the at least one weak personality trait;
recommending an option to select happiness as a trait to be worked on, only after recommending the option to select the at least one weak relationship; wherein,
the option to select the at least one weak relationship is recommended based on performance of one or more actions corresponding to the at least one weak personality trait, if selected; and
the option to select happiness as the trait is recommended based on performance of one or more actions corresponding to the at least one weak relationship, if selected.
